(19) United States
(12) Patent Application Publication
(10) Pub. No.: US 2026/0312768 A1
(43) Pub. Date: Oct. 8, 2026

(54) DEVICE, METHOD AND COMPUTER READABLE MEDIUM FOR COMMUNICATIONS

(71) Applicant: NEC Corporation, Tokyo (JP)

(72) Inventors: Xincai LI, Beijing (CN); Gang WANG, Beijing (CN)

(73) Assignee: NEC Corporation, Tokyo (JP)

(21) Appl. No.: 19/489,063

(22) PCT Filed: Jun. 6, 2023
(86) PCT No.: PCT/CN2023/098694

§ 371 Date: Dec. 1, 2025

(51) Int. Cl. H04L 5/00; H04L 5/14

(52) U.S. Cl. CPC H04L 5/0053; H04L 5/14

(57) ABSTRACT

Embodiments of the present disclosure relate to devices, methods and computer readable medium for a random access procedure. According to embodiments of the present disclosure, the terminal device receives, from a network device, a PRB bundling configuration that indicates a precoding granularity for a downlink channel in an SBFD time unit. The SBFD time unit is configured with frequency subbands for different link directions. Then, the terminal device determines, based on the PRB bundling configuration and within one or more downlink frequency subbands of the SBFD time unit, a PRB bundling having the precoding granularity or another adapted precoding granularity. In this way, the channel precoding can be optimized for the SBFD mechanism.

This is a National Stage of International Application No. PCT/CN2023/098694 filed Jun. 6, 2023.

### FIELD

Embodiments of the present disclosure generally relate to the field of communication, and in particular, to devices, methods and computer readable medium for multiple antenna precoding.

### BACKGROUND

With the development of communication technology, a time unit (for example, a symbol, slot, frame, sub-frame and so on) can be divided into a plurality of frequency subbands in the frequency domain. The plurality of frequency subbands may be respectively used for different link directions, for example, uplink (UL) or downlink (DL). This time unit may be also referred to as subband non-overlapping full duplex (SBFD) time unit. In turn, a device for communication (for example, a network device or a terminal device) may perform the simultaneous transmission and reception of channel in different link directions on these time units, in order to improve communication efficiency.

In addition, multi-antenna techniques may be used to increase the data rates and reliability of a wireless communication system. The performance can be particularly improved if both the transmitter and the receiver are equipped with multiple antennas, which results in a multiple-input multiple-output (MIMO) communication channel. Such systems and/or related techniques are commonly referred to as MIMO. In an example, an 8-layer spatial multiplexing mode is supported for 8 transmit (Tx) antennas with channel dependent precoding. In this case, a precoding matrix (or precoder, or precoder matrix) should be determined at a base station (BS) and user equipment (UE) for encoding or decoding the data transmission with respect to the multiple antennas in a predefined rule. In turn, precoding channel adjustment in the MIMO is a key aspect in the case of deploying the SBFD mechanism.

### SUMMARY

In general, example embodiments of the present disclosure relate to devices, methods, and computer readable medium for multiple antenna precoding.

In a first aspect, there is provided a terminal device. The terminal device comprises a processor. The processor is configured to cause the terminal device to receive, from a network device, a physical resource block (PRB) bundling configuration that indicates a precoding granularity for a downlink channel in a subband non-overlapping full duplex (SBFD) time unit. The SBFD time unit is configured with frequency subbands for different link directions. The terminal device is further caused to determine, based on the PRB bundling configuration and within one or more downlink frequency subbands of the SBFD time unit, a PRB bundling having the precoding granularity or another adapted precoding granularity.

In a second aspect, there is provided a network device. The network device comprises a processor. The processor is configured to cause the network device to determine, based on one or more downlink frequency subbands of an SBFD time unit, a precoding granularity for a downlink channel in the SBFD time unit. The SBFD time unit is configured with frequency subbands for different link directions. The network device is further caused to transmit, to a terminal device, a PRB bundling configuration indicating the precoding granularity.

In a third aspect, there is provided a method implemented at a terminal device. In the method, the terminal device receives, from a network device, a PRB bundling configuration that indicates a precoding granularity for a downlink channel in an SBFD time unit. The SBFD time unit is configured with frequency subbands for different link directions. Then, the terminal device determines, based on the PRB bundling configuration and within one or more downlink frequency subbands of the SBFD time unit, a PRB bundling having the precoding granularity or another adapted precoding granularity.

In a fourth aspect, there is provided a method implemented at a network device. In the method, the network device determines, based on one or more downlink frequency subbands of a SBFD time unit, a precoding granularity for a downlink channel in the SBFD time unit. The SBFD time unit is configured with frequency subbands for different link directions. Then, the network device transmits to a terminal device, a physical resource block (PRB) bundling configuration indicating the precoding granularity.

In a fifth aspect, there is provided a computer readable medium having instructions stored thereon, the instructions, when executed on at least one processor, causing the at least one processor to perform the method of the third aspect or the fourth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1a illustrates an example environment in which some embodiments of the present disclosure can be implemented;

FIG. 1b illustrates an example of a mismatch between PRB bundling for channel precoding and the frequency subband division of an SBFD time unit;

FIG. 2 illustrates a signaling process for multiple antenna precoding according to some embodiments of the present disclosure;

FIGS. 3a to 3c illustrate examples of PRB bundling adapted for downlink frequency subbands of the SBFD time unit according to some embodiments of the present disclosure;

FIGS. 4a to 4b illustrate examples of wideband granularity channel precoding according to some embodiments of the present disclosure;

FIG. 5a illustrates an example criterion for determining the “wideband” granularity of channel precoding according to some embodiments of the present disclosure;

FIG. 5b illustrates an example of precoding granularity adapted for the SBFD time unit according to some embodiments of the present disclosure;

FIG. 6 illustrates a flowchart of an example method implemented at a terminal device according to some embodiments of the present disclosure;

FIG. 7 illustrates a flowchart of an example method implemented at a network device according to some embodiments of the present disclosure; and

FIG. 8 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may be also incorporated one or multiple Subscriber Identity Module (SIM) as known as Multi-SIM. The term “terminal device” can be used interchangeably with a UE, a mobile station, a subscriber station, a mobile terminal, a user terminal, a wireless device or a reduced capability terminal device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information. The terminal or the network device may work on several frequency ranges, e.g. FR1 (410 MHz-7125 MHz), FR2 (24.25 GHz to 71 GHz), 71 GHz to 114 GHz, and frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware. In this disclosure, the subband and the frequency subband may be used interchangeable without any limitation. The group size of a RBG may be also referred to as the RBG size without any limitation. In this disclosure, the control channel may be interchangeably used with the physical downlink control channel (PDCCH) without any limitation.

The time unit configured with SBFD communication or configuration may be also referred to as SBFD time unit, and the time unit not configured with SBFD communication may be also referred to as non-SBFD time unit.

In this disclosure, the time unit may be any time duration, for example, symbol, slot, subframe and frame and so on. Without any limitation, only for illustration purposes, these time scales can be used interchangeably.

The term “Physical Resource Block (PRB) or resource block” may refer to a resource base unit in the frequency domain.

The term “SBFD aware UE” used herein may refer to the terminal device which obtains the SBFD configuration for time units, for example, the subband division or location of the time units, and supports the SBFD operations with the network device.

The term “precoding granularity” used herein may refer to a frequency bandwidth size for constituting a PRB bundling, and the PRB bundling is associated with the channel encoding or decoding. In an example, this frequency bandwidth size (or the precoding granularity) may be represented by a number of PRBs, for example, 2 PRBs, 4 PRBs or other number of PRBs. In this case, the constituted PRB bundling may be also referred to as a “precoder resource group (PRG)” without any limitation. Once the precoding granularity is determined, one or more PRB bundling may be divided based on the precoding granularity within the allocated frequency bandwidth, such as, the bandwidth part (BWP) specific to the terminal device. In some general, the same precoding (or channel precoding) is applied within a PRB bundling having the precoding granularity, or within the precoding granularity. Furthermore, the precoding matrix associated with mapping between data channel transmission and the multiple antennas corresponds to (or is specific to) the PRB bundling. In the MIMO system, if the PRB bundling is divided or determined, the BS or UE may encode or decode channel based on the precoding matrix corresponding to the PRB bundling. In this disclosure, the precoding matrix may be also referred to as the “precoder” or “precoder matrix” without any limitation. That is, the terms “precoding matrix”, “precoder” or “precoder matrix” may be used interchangeably in this disclosure.

In another example, this frequency bandwidth size (or the precoding granularity) may be represented by “wideband”, for example, in the case that the allocated PRBs are above half of the bandwidth part (BWP) specific to UE. If the precoding granularity is the wideband granularity, the RBs allocated for the channel should be continuous in the frequency domain, and the same precoding matrix is applied.

In this disclosure, the terms “frequency subband” and “subband” can be used interchangeably without any limitation.

As mentioned above, precoding channel adjustment in the MIMO is a key aspect in the case of deploying SBFD mechanism. In general, the PRB bundling is based on the precoding granularity and the BWP. That is, one or more PRB bundling are divided, in the unit of the precoding granularity, within the BWP. In addition, in some cases, the resources for one PRB bundling should be continuous in the frequency domain.

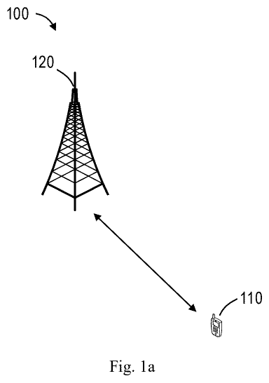

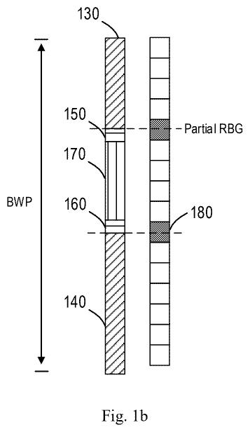

However, in the SBFD communication, the BWP during SBFD time unit may be divided into different frequency subbands, for example, downlink frequency subband, uplink frequency subband and guardband. In this case, the existing PRB bundling that is based on the precoding granularity and the BWP may mismatch with the frequency subband division of the SBFD time unit. For example, the PRB bundling for downlink channel precoding may overlap with the guardband or uplink frequency subband of the SBFD time unit. This may result in incorrectly determining the precoding matrix which may further cause the downlink channel encoding or decoding errors. For discussion clarity, the above mismatch will be further discussed with reference to FIG. 1b.

At least for solving the above technical issues, the example embodiments of the disclosure propose a mechanism for multiple antenna precoding. In this mechanism, a terminal device receives, from a network device, a PRB bundling configuration that indicates a precoding granularity for a downlink channel in an SBFD time unit. The SBFD time unit is configured with frequency subbands for different link directions. Then, the terminal device determines, based on the PRB bundling configuration and within one or more downlink frequency subbands of the SBFD time unit, a resource block bundling having the precoding granularity or another adapted precoding granularity.

In this way, the PRB bundling for the downlink channel (for example, a physical downlink shared channel, PDSCH) can be determined appropriately by adapting the precoding granularity to the downlink frequency subband of the SBFD time unit. As such, the downlink channel precoding procedure can be optimized with respect to the SBFD mechanism.

FIG. 1 illustrates an example environment 100 in which example embodiments of the present disclosure can be implemented.

The environment 100, which may be a part of a communication network, comprises a terminal device 110 and a network device 120. In some embodiments, the communication network may include NTN, NB-IoT and/or eMTC. In some other embodiments, the communication network may include any other possible communication network. It is to be understood that the number of network devices and terminal devices is given only for the purpose of illustration without suggesting any limitations. The communication network may include any suitable number of network devices and/or terminal devices adapted for implementing embodiments of the present disclosure. Although not shown, it would be appreciated that one or more terminal devices may be located in the environment 100. Without any limitation, the network device 120 supports the SBFD communication. For example, the network device 120 may transmit downlink (DL) channel to the terminal device 110 and receive UL channel from another terminal device (not shown in FIG. 1A) in the SBFD time unit, simultaneously. In this disclosure, the non-SBFD time unit may be UL only time unit or DL only time unit.

FIG. 1b illustrates an example of a mismatch between PRB bundling for channel precoding and the frequency subband division of an SBFD time unit.

As mentioned above, the mismatch between the existing PRB bundling and the frequency subband division of the SBFD time unit may occur. As shown in FIG. 1b, the frequency subbands 130 and 140 are configured for the downlink direction, and the frequency subbands 130 and 140 may be also referred to downlink frequency subbands. The frequency subbands 150 and 160 are configured as guard bands. The frequency subband 170 is configured for the uplink direction, and the frequency subband 170 may be also referred to as the uplink frequency subband. It can be seen that no matter the precoding granularity is 2 PRBs, 4 PRBs or wideband, the PRB bundling (or PRG) divided, for example based on the precoding granularity, within the whole BWP may be not aligned with the boundary of the subbands in the SBFD time unit. As such, a PRB bundling may overlap with both the downlink frequency subband and the guardband (or the uplink frequency subband), as shown by the PRB bundling (or PRG) 180. That is, a part of the PRG 180 may be occupied by UL subband or guard band.

In the example as shown in FIG. 1b, if the precoding granularity is 4 PRBs, then the PRG 180 may have 4 PRBs, and two PRBs is within the downlink frequency subband, two PRBs is within the guard band. The PRG 180 may be also referred to as a partial PRG in this disclosure, which means that a part of the PRG is within the downlink frequency subband, and another part of the PRG may be within another frequency subband. In this case, how to determine the precoding matrix used for these PRBs in the PRB bundling should be studied.

In addition, in the wideband precoding case, currently, the UE does not expect to be scheduled with non-contiguous resource blocks, and it assumes that the same precoding matrix is applied to all the resource blocks of the PRB bundling. If non-contiguous allocation is supported across DL subbands in the SBFD time unit, the wideband precoding granularity cannot be applied.

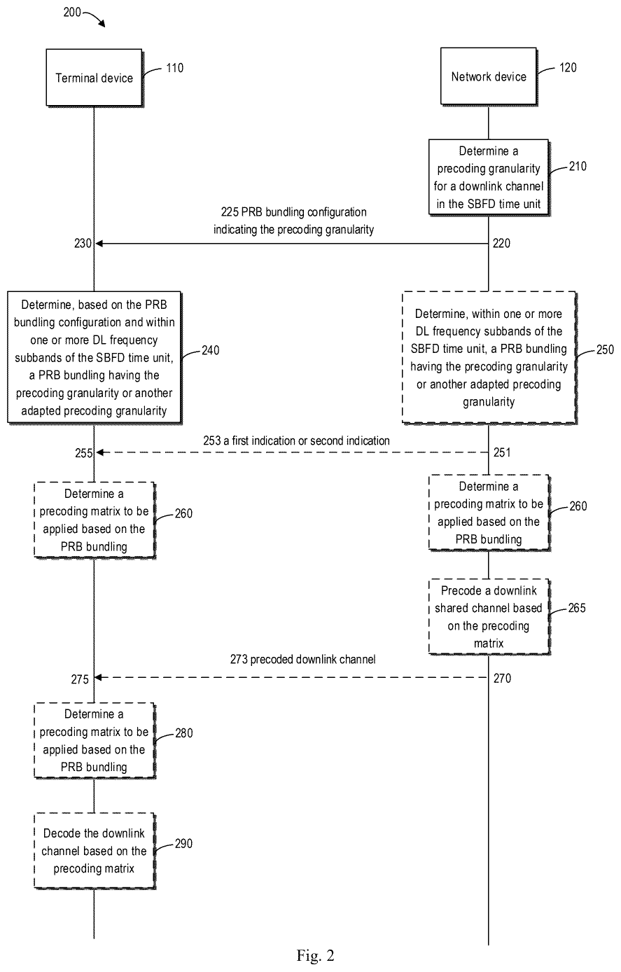

FIG. 2 illustrates a signaling process 200 for multiple-antenna precoding according to some embodiments of the present disclosure. For illustrative purposes, the process 200 will be described with reference to FIG. 1.

In the signaling process 200, the network device 120 determines (210) a precoding granularity for a downlink channel in a SBFD time unit, based on one or more downlink frequency subband of the SBFD time unit. The precoding granularity may comprise one of: two PRBs, four PRBs, eight PRBs, sixteen PRBs, thirty two PRBs, a subband or a wideband granularity. In some embodiments, the network device 120 may determine a precoding granularity that is adapted for the downlink frequency subbands of the SBFD time unit. For example, the network device 120 may select a precoding granularity such that the number of resource blocks in the downlink frequency subband is an integer multiple of the precoding granularity. In this way, the possibility of occurring the above mismatch may be reduced. Without any limitation, the network device 120 may determine the precoding granularity in any other ways that considers the downlink frequency subbands of the SBFD time unit.

Then, the network device 120 transmits (220) a PRB bundling configuration 225 to the terminal device 110, and the PRB bundling configuration 225 indicates the precoding granularity for the downlink channel in the SBFD time unit. Accordingly, the terminal device 110 receives (230) this PRB bundling configuration 225 from the network device 120. With the PRB bundling configuration 225, the terminal device 110 determines (240), within one or more downlink frequency subbands of the SBFD time unit, a PRB bundling having the precoding granularity or another adapted precoding granularity.

In this disclosure, the other adapted precoding granularity may be different from the indicated precoding granularity. In turn, the other adapted precoding granularity may be determined based on both the indicated precoding granularity and the downlink frequency subbands of the SBFD time unit, such that avoiding the occurrence that a PRB bundling overlaps with the frequency subbands other than the downlink frequency subbands.

In some embodiments, the terminal device 110 may initially determine the PRB bundling (which may be also referred to as the initial PRB bundling) based on the BWP and the indicated precoding granularity. In an example, if the precoding granularity is indicated as 2 PRBs or 4 PRBs, the size of the initial PRB bundling except for the first PRB bundling or the last PRB bundling in the BWP is this precoding granularity. Moreover, the first PRB bundling or the last PRB bundling may be adjusted to align with the boundary of the BWP. However, as mentioned above, an initial PRB bundling of the plurality of determined initial PRB bundling may overlap with the frequency subbands other than the downlink frequency subbands. In this case, the terminal device 110 may adjust this initial PRB bundling to have the other adapted precoding granularity, in order to avoid the above overlapping.

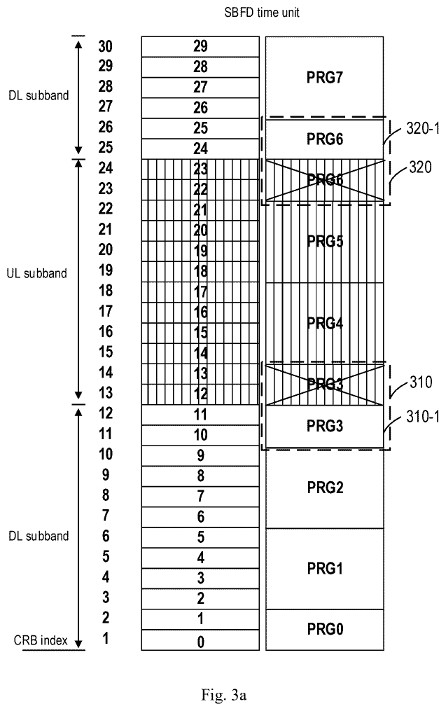

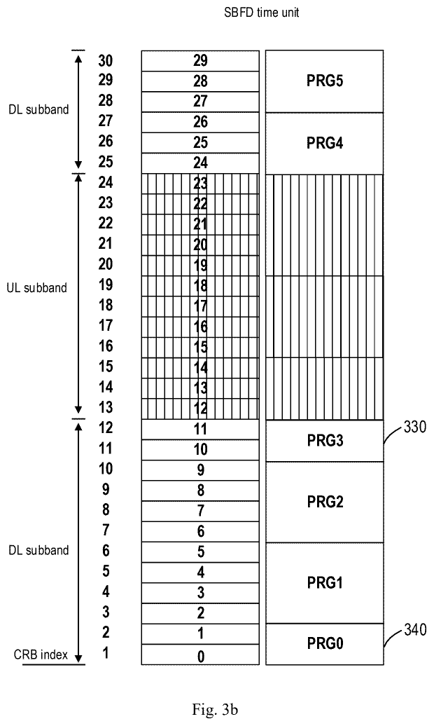

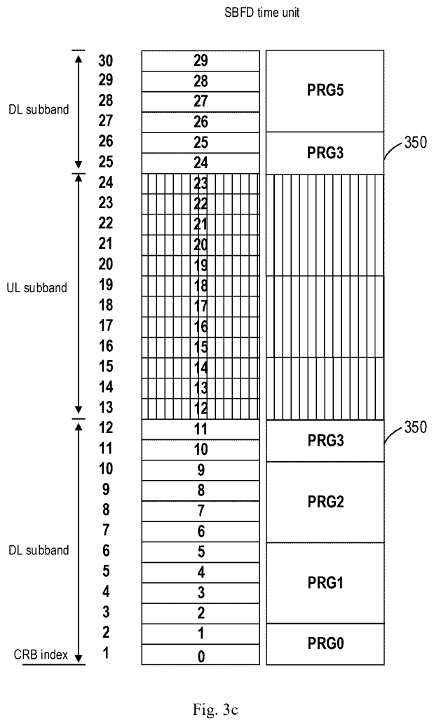

In an example, the terminal device 110 may determine whether an initial PRB bundling divided based on the precoding granularity overlaps with both a downlink frequency subband and another frequency subband in the SBFD time unit. If determining that the initial PRB bundling overlaps with both the downlink frequency subband and the other frequency subband, the terminal device 110 may determine a first partial number of PRBs in the initial PRB bundling as the other adapted precoding granularity, and the first number of PRBs within the initial PRB bundling does not overlap with the other frequency subband. Then, the terminal device 110 may replace the initial PRB bundling with the PRB bundling having the other adapted precoding granularity. In this way, by means of determining the PRB bundling having the other adapted precoding granularity, the above overlapping can be avoided. Only for discussion clarity, the above embodiments are further discussed with reference to FIG. 3a.

FIG. 3a illustrates an example of PRB bundling adapted for downlink frequency subbands of the SBFD time unit according to some embodiments of the present disclosure.

As shown in FIG. 3a, for the initial PRGs 310 and 320 having 2 PRBs and 4 PRBs or only 4 PRBs (as shown in FIG. 3a) that overlaps with another subband other than the downlink frequency subband, a part of the PRG (which may be also referred to the partial PRG) can be used for the channel precoding. In the example of FIG. 3a, the PRG division is not changed and it is still based on BWP. However, only partial resources (i.e., the partial PRG) in the PRG are considered as valid PRBs for PDSCH doing precoding, the partial resources do not overlap with UL subband or guardband. In this case, the PRBs that do not overlap with UL subband or guardband in the same initial PRG may be applied to the same precoding matrix. In an example, the minimum size of partial PRG may be {1 PRB, 2PRBs, 3PRBs}.

In the example of FIG. 3a, the configured/indicated precoding granularity is 4 (PRBs), then only the PRBs in the PRG not overlapped with the UL subband or guardband is considered as valid PRB for PDSCH precoding. Such as for PRG3 and PRG6, only the PRB in the DL subband are considered as valid PRB for precoding.

Without any limitation, the above embodiments may be also expressed as below: The UE may assume the same precoding is applied to any downlink contiguous allocation

The UE may assume the same precoding is applied to any downlink
contiguous allocation of PRBs in a PRG that not overlapping with UL
subband or guard band.

Referring back to FIG. 2, alternatively, if determining that the initial PRB bundling does not overlap with both the downlink frequency subband and the other frequency subband (for example, the network device 120 selects an appropriate precoding granularity adapted for the downlink subbands of the SBFD time unit), the terminal device 110 may directly use the precoding matrix corresponding to the PRB bundling having the indicated precoding granularity without adjusting the initial PRB bundling.

Alternatively, the terminal device 110 may also determine, at the boundary of the downlink frequency subbands, the PRB bundling having the other adapted precoding granularity. That is, compared to the BWP and the indicated precoding granularity, the terminal device 110 may determine one or more PRB bundling within the downlink frequency subbands based on the downlink frequency subband and the indicated precoding granularity. In some embodiments, the terminal device 110 may determine, based on a downlink frequency subband in the SBFD time unit and the precoding granularity, the other adapted precoding granularity for a PRB bundling at a boundary of the downlink frequency subband, such that the PRB bundling at the boundary does not overlap with a guardband or uplink frequency subband in the SBFD time unit. Only for discussion clarity, the above embodiments are further discussed with reference to FIG. 3b.

FIG. 3b illustrates another example of PRB bundling adapted for downlink frequency subbands of the SBFD time unit according to some embodiments of the present disclosure.

As mentioned above, for SBFD aware UE configured with precoding granularity (for example, the PRG size) of 2 and 4 PRBs, or only 4 PRBs, the PRB bundling division (or PRG division) may be changed for the SBFD time unit. Certain PRGs at the boundaries of the downlink frequency subband may have the other adapted precoding granularity that is similarly handled as fractional PRGs at the boundaries of BWP. In each DL subband, the PRG is separately divided, and the division method is as similar to the PRG division within the BWP. For example, a PRG is partitioned between boundaries of one downlink frequency subband. In this case, the number of the allocated RBs in the PRG at the edge of each DL subband may be smaller than indicated precoding granularity.

As shown in FIG. 3b, the first PRG (PRG 0) 340 and the last PRG (PRG 3) 330 in the DL subband may include a number of PRBs smaller than the indicated precoding granularity, for example, 4 PRBs. Without any limitation, the above embodiments may be also expressed as below:

The size of the first PRG in the DL subband (the PRG, if there it is, adjacent to one
$boundary of the subband ) is {P}_{subband , i}^{′} - {N}_{Subband , i}^{start} mod {P}_{subband , i}^{′} , the size of last PRG$
$( another PRG , if there it is , adjacent to another boundary of the subband ) is ( {N}_{Subband , i}^{start} +$
${N}_{Subband , i}^{size} ) mod {P}_{Subband , i}^{′} wherein the {P}_{subband , i}^{′} is the precoding granularity ( for example ,$
$a number of PRBs ) for the DL subband , {N}_{Subband , i}^{start} is the sequence number of the starting$
PRB of the common frequency resources (for example, the number of PRBs) for the DL
$subband , {N}_{Subband , i}^{size} is the common frequency resources ( for example , the number of$
PRBs) within the DL subband.

Referring back to FIG. 2, alternatively, the terminal device 110 may also determine the PRB bundling for the downlink channel in the SBFD time unit by omitting the PRBs within the frequency subbands other than the downlink frequency subbands. In some embodiments, the terminal device 110 may determine, based on the indicated precoding granularity, a plurality of PRB bundling within the one or more downlink frequency subbands by omitting PRBs of a guardband and uplink frequency subband in the SBFD time unit. In this case, one of the plurality of PRB bundling may include two subsets of PRBs, and the two subsets of PRBs are located in two downlink frequency subbands of the SBFD time unit, respectively. Only for discussion clarity, the above embodiments are further discussed with reference to FIG. 3c.

FIG. 3c illustrates a further example of PRB bundling adapted for downlink frequency subbands of the SBFD time unit according to some embodiments of the present disclosure.

As shown in FIG. 3c, for PRG(s) having 2 and 4 PRBs or only 4 PRBs, certain PRG 350 may include the PRBs that are discontinuous in the frequency domain. In this case, the precoding matrix that is the same as the precoding matrix corresponding to the PRG 1, PRG 2, or PRG5 may be used for PRG 350. Moreover, joint channel estimation across these two DL frequency subbands may be needed.

In this way, a new PRG numbering method is introduced for SBFD symbols, and the PRG numbering is associated with the two discontinuous DL frequency subbands by omitting the UL subband and the guardband resource in the SBFD slot. That is, the UL subband and the guardband may be considered to be subtracted when numbering the PRG for PDSCH precoding. Therefore, the PRB/PRG indices in the two DL subband are continuous arranged and uniformed in SBFD slot. As shown in FIG. 3c, PRG 350 (i.e., PRG 3) includes 4 PRBs (PRB10, PRB11, PRB24, and PRB25) in a discontinuous way.

Referring back to FIG. 2, in the case that the precoding granularity is wideband granularity, the terminal device 110 may similarly determine the PRB bundling by considering the characteristics of the SBFD time unit.

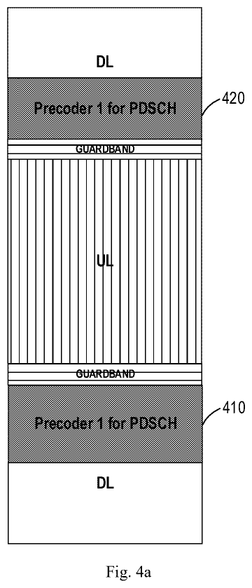

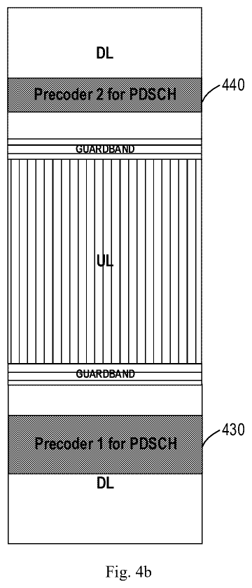

In some embodiments, the downlink channels (for example, PDSCH) may be configured on more than one downlink frequency subband of the SBFD time unit and the precoding granularity is the wideband granularity. In this case, the non-continuous PRBs for one or more PRB bundling in the case of the wideband granularity may be enabled. Furthermore, the same precoding matrix may be applied to the PRB bundling having non-continuous PRBs. In some embodiments, the terminal device 110 may determining, in the SBFD time unit, a first PRB bundling size within a first downlink frequency subband and a second PRB bundling size within a second downlink frequency subband. For example, the first and second PRB bundling size may be determined based on the resource scheduling for the downlink channel on the more than one downlink frequency channel. Without any limitation, the first PRB bundling and the second PRB bundling may be also considered as one PRB bundling which has non-continuous PRBs. Then, the same precoding matrix may be applied to the first PRB bundling and the second PRB bundling. Only for discussion clarity, the above embodiments are further discussed with reference to FIG. 4a.

FIG. 4a illustrates an example of wideband granularity channel precoding according to some embodiments of the present disclosure.

In the example of FIG. 4a, when the precoding granularity is set to “wideband” and terminal device 110 is scheduled with a downlink channel on two DL subbands of the SBFD time unit, and the UL subband and guardband may be considered as rate matching resources or blanked resources for PDSCH precoding. In this way, non-continuous PRBs in two DL subbands may use the same precoding matrix. In this case, new terminal device behavior may be introduced, such as the terminal device does not need to perform channel quality indication (CQI) calculation for the RBs in UL subband and guardband and use the same precoder in non-contiguous frequency domain resource allocation (FDRA) across DL subbands.

As shown in FIG. 4a, the terminal device 110 may be scheduled with non-contiguous resources for the downlink channels (as shown by reference number 410 and 420) on two DL subbands of the SBFD symbols. In this case, the scheduled PDSCHs may use the same precoder (precoder1 as shown in FIG. 4a) to perform the channel precoding or decoding for the allocated PRB, if “wideband” precoding granularity is configured or indicated. Without any limitation, the above embodiments may be also expresses as below:

Below descriptions can be added in TS 38.214 section 5.1.2.3.
If precoding granularity is determined as “wideband”, and if UE is scheduled with
non-contiguous PRBs in two subbands in SBFD symbols and the UE may assume that the
same precoding is applied to the allocated resource associated with a same TCI state or a
same QCL assumption in the non-contiguous PRBs of the two DL subband.

In addition, in some embodiments, only if the difference between channel conditions within the first DL subband and the channel conditions within the second DL subband is smaller than a channel difference threshold, the same precoding matrix is applied under the wideband granularity. For example, the above embodiments are used when the difference of the channel conditions in two DL subband is within a small range. In this way, the performance of the channel precoding can be ensured.

Referring back to FIG. 2, alternatively, even if the precoding granularity is the wideband granularity, the non-continuous RBs for the PRB bundling and different precoders (i.e., procoding matrix) may be enabled. In some embodiments, one downlink channel (for example, PDSCH) may be scheduled on more than one downlink frequency subband of the SBD time unit and the precoding granularity is the wideband granularity. In this case, the terminal device 110 may determine, in the SBFD time unit, a first PRB bundling within a first downlink frequency subband and a second PRB bundling within a second downlink frequency subband. Then, the terminal device 110 may apply a first precoding matrix to the first PRB bundling and a second precoding matrix to the second PRB bundling, respectively. In this way, the precoding assumption is per frequency subband of the SBFD time unit. Only for discussion clarity, this embodiment is further discussed with reference to FIG. 4b.

FIG. 4b illustrates another example of wideband granularity channel precoding according to some embodiments of the present disclosure.

In the example of FIG. 4b, if the terminal device 110 is scheduled with one PDSCH on two DL subbands, and “wideband” precoding granularity is indicated, different PRBs scheduled for PDSCH in different DL subband may be applied different precoder matrices. Furthermore, the same precoding matrix may be used for scheduled PRBs in the same DL subband. That is, the precoding assumption is per subband. Moreover, for PDSCH, the allocated resources in each DL subband are associated with the same transmission configuration indication (TCI) state or a same quasi co-location (QCL) assumption. Without any limitation, the above embodiment may be also expressed as below.

Below revision can be made in TS 38.214 section 5.1.2.3.
If precoding granularity is determined as “wideband”, the UE is scheduled with
non-contiguous PRBs in different DL subbands and the UE may assume that the same
precoding is applied to the allocated resource associated with a same TCI state or a same
QCL assumption in each DL subband.

Referring back to FIG. 2, In addition, the network device 120 may also determine (250) the PRB bundling in the same way as discussed with reference to the operation 240. In addition or alternatively, the network device 120 may transmit an indication regarding whether to use the same precoding matrix to the terminal device 110. In some embodiments, the network device 120 may transmit (251), to the terminal device 110, a first indication 253 indicating that same precoding matrix is applied to the downlink frequency subbands in the SBFD time unit. Alternatively, the network device 120 may transmit (251), to the terminal device 110, a second indication 253 indicating that different precoder matrices are applied to downlink frequency subbands in the SBFD time unit. The first indication or second indication may be determined based on channel states of the downlink frequency subbands of the SBFD time unit. For example, the network device 120 may, for example based on the Channel State Information (CSI) reported by the terminal device 110, determine whether a difference between a first channel state of a first downlink frequency subband and a second channel state of a second downlink frequency subband is above a threshold. Without any limitation, the network device 120 may determine whether the difference is above the threshold in any other manners, for example estimating the channel quality by itself. If the difference is not above the threshold, the network device 120 may transmit the above first indication. Otherwise, if the difference is above the threshold, the network device 120 may transmit the above second indication. Then, the terminal device 110 may receive (255) the first indication or second indication 253 accordingly.

In an example, a new bit field can be added in downlink control information (DCI) format 1_x, and this information is used for indicating UE whether the same or different precoding assumption is used for the PRBs in two DL subbands. Furthermore, the network device 120 may indicate to use the same precoding matrix only within one DL subband or to use same precoding matrix across the two DL subbands based on CSI feedback from the terminal device 110.

When the difference between the channel conditions of the CSI feedback for two DL subbands is within a range or a threshold, then the network device 120 may indicate the terminal device 110 to use the same precoding matrix (or the same precoding assumption) for PDSCH scheduled in two DL subbands. Otherwise, if the difference between the channel conditions of the CSI feedback for two DL subbands is above a range or a threshold, then the network device 120 indicate the terminal device 110 to use different precoding matrices (or the different precoding assumption) for the PDSCH scheduled in two DL subbands, and the RBs in the same subband may be applied with the same precoding matrix. Without any limitation, the above embodiments may be also expressed as below:

Below descriptions can be added in TS 38.212 section 7.3.1.2.2 and 7.3.1.2.3.
Precoding assumption indicator- 1 bit if the precoding granularity is set to ‘wideband’
according to Clause 5.1.2.3 of [6, TS 38.214], otherwise 0 bit.
Value 0 of this bit field indication same precoding assumption used for PDSCH scheduled
in two DL subbands or the allocated resource in two DL subband are associated with a
same TCI state or a same QCL assumption. And value 1 of this bit field indication different
precoding assumption used for PDSCH scheduled in two DL subbands or the allocated
resource in two DL subbands are associated with different TCI states or different QCL
assumption.

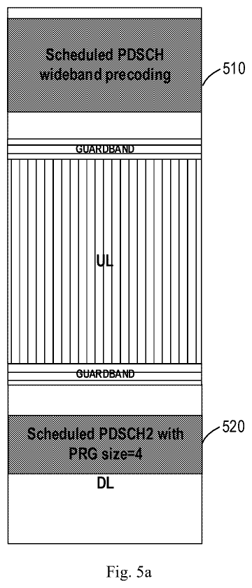

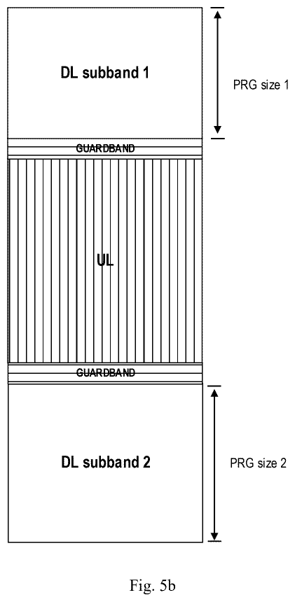

In addition, the determining criterion for indicating so-called “wideband” granularity may be also adjusted based on the DL frequency subbands of the SBFD time unit. In some embodiments, the wideband granularity is set based on a number of PRBs scheduled for the downlink channel and a bandwidth of the downlink frequency subband in the SBFD time unit. Specifically, if a first bandwidth of PRBs allocated in a downlink frequency subband is equal to or above half of a second bandwidth of the downlink frequency subband, the precoding granularity may be set to the wideband granularity. Only for discussion clarity, the adjusted determining criterion is further discussed with reference to FIG. 5a.

FIG. 5a illustrates an example criterion for determining the “wideband” granularity of channel precoding according to some embodiments of the present disclosure.

In some embodiments, when precoding granularity is set to “wideband” and is indicated to the terminal device 110, the terminal device 110 (for example, the SBFD-aware UE) is configured with contiguous PRBs only in one DL subband.

Besides, a threshold or condition can be defined for the network device 120 or terminal device 110 to judge whether the wideband granularity can be applied based on the allocated PRB for PDSCH. In an example, only if the allocated PDSCH bandwidth exceed this threshold, then wideband precoding granularity can be indicated/determined, otherwise only precoding granularity 2 or 4 can be indicated/determined for PDSCH precoding.

The threshold or condition for the network device 120 or terminal device 110 to determine wideband granularity or narrowband granularity may comprise that the number of scheduled RBs bandwidth in one DL subband for PDSCH exceeds half of the size of the DL subband. As shown in FIG. 5a, the precoding granularity associated with the scheduled PDSCH 510 may be the wideband granularity, if the bandwidth of scheduled PRBs for this PDSCH 510 is equal to or greater than the threshold, for example, half of the bandwidth of the DL frequency subband. In turn, the precoding granularity associated with the scheduled PDSCH 520 may be the narrowband granularity, for example, 4PRBs, since the bandwidth of scheduled PRBs for the PDSCH 520 is smaller than the threshold. Without any limitation, the above embodiments may be also expressed as below:

Below descriptions can be added in TS 38.214 section 5.1.2.3.
For SBFD-aware UE, wideband precoding granularity can be selected/determined if the
allocated RBs exceed half of the DL subband size, otherwise only precoding granularity 2
or 4 can be determined or indicated. If precoding granularity is determined as
“wideband”, UE expect that the allocated PRB is within one DL subband, and the UE may
assume that the same precoding is applied to the allocated resource associated with a same
TCI state or a same QCL assumption in this DL subband.

In addition or alternatively, the above precoding granularity may have a plurality candidate values or bandwidths. In some embodiments, the precoding granularity may comprise: two PRBs, four PRBs, eight PRBs, sixteen PRBs, thirty two PRBs, a subband or a wideband granularity. The subband granularity may be the bandwidth of the downlink frequency subband on which the PDSCH is scheduled. Only for discussion clarity, the precoding granularity is further discussed with reference to FIG. 5b.

FIG. 5b illustrates an example of precoding granularity adapted for the SBFD time unit according to some embodiments of the present disclosure.

As mentioned above, the precoding granularity may be other values in addition to the 2 PRBs, 4PRBs and the wideband granularity. In an example, the precoding granularity may be equal to the bandwidth size of the DL frequency subband, 4 PRBs, 8 PRBs, 16 PRBs or 32 PRB. In this case, the PRB bundling division may be based on the BWP or DL subband.

In the case of subband based precoding, for PDSCH across two DL subbands, each PRG size for precoding PDSCH in the scheduled subband may equal to each DL subband size. That is, all the PRB used by PDSCH in the same DL subband or the new granularity may use the same precoding matrix.

As shown in FIG. 5b, the PRG size 1 for the precoding PDSCH in DL subband 1 may equal to the size of DL subband1, and the PRG size 2 for the PDSCH precoding in DL subband 2 may equal to the size of DL subband 2. Without any limitation, the above embodiments may be also expressed as below:

The candidate value for PRB bundling in 38.331 can include subband, 4, 8, 16, 32PRB, and
if it is configured as subband, the subband size is equal to the DL subband size.

Referring back to FIG. 2, with the determination operations 240 and 250 and/or the indication 253, the network device 120 and terminal device 110 may determine the same PRB bundling for precoding or decoding the downlink channel. As mentioned above, the precoding matrix may correspond to or specific to the PRB bundling. Then, the network device 120 may determine (260) the precoding matrix to be applied based on the PRB bundling. Then, the network device 120 may pre-code (265) the downlink channel (for example, the PDSCH) by using the precoding matrix, and transmit (270) the precoded downlink channel 273 to the terminal device 110.

In turn, the terminal device 110 may receive (275) the precoded downlink channel 273 accordingly. Similarly, the terminal device 110 may determine (280) the precoding matrix to be applied. Then, the terminal device 110 may decode the precoded downlink channel 273 by using the precoding matrix.

In this way, the disclosure adapts the downlink channel precoding procedure to the SBFD mechanism, in order to avoid the possible mismatch between the PRB bundling and the frequency subband division. As such, the performance of the MIMO system may be enhanced with respect to multiplexing time domain resources.

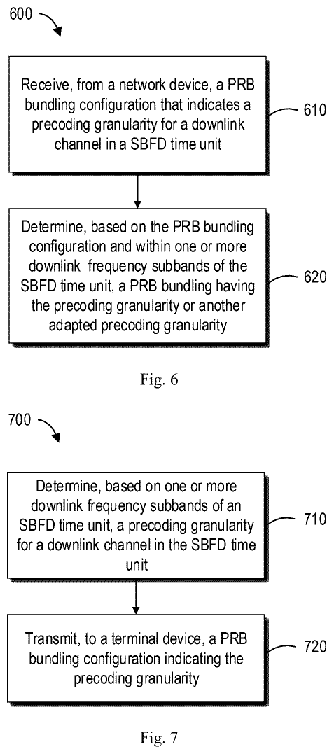

FIG. 6 illustrates a flowchart of a method 600 of communication implemented at a terminal device in accordance with some embodiments of the present disclosure. The method 600 can be implemented at the terminal device 110 shown in FIG. 1. For the purpose of discussion, the method 600 will be described with reference to FIG. 1. It is to be understood that the method 600 may include additional acts not shown and/or may omit some shown acts, and the scope of the present disclosure is not limited in this regard.

At 610, the terminal device 110 receives, from a network device, a PRB bundling configuration that indicates a precoding granularity for a downlink channel in an SBFD time unit. The SBFD time unit is configured with frequency subbands for different link directions. At 620, the terminal device 110 determines, based on the PRB bundling configuration and within one or more downlink frequency subbands of the SBFD time unit, a PRB bundling having the precoding granularity or another adapted precoding granularity.

In some embodiments, the terminal device 110 may determine the PRB bundling having the other adapted precoding granularity by: determining whether an initial PRB bundling divided based on the precoding granularity overlaps with both a downlink frequency subband and another frequency subband in the SBFD time unit; determining, based on determining that the initial PRB bundling overlaps with both the downlink frequency subband and the other frequency subband, a first number of PRBs in the initial PRB bundling as the other adapted precoding granularity, wherein the first number of PRBs within the initial PRB bundling does not overlap with the other frequency subband; and replacing the initial PRB bundling with the PRB bundling having the other adapted precoding granularity.

In some embodiments, the terminal device 110 may determine the PRB bundling having the other adapted precoding granularity by: determining, based on a downlink frequency subband in the SBFD time unit and the precoding granularity, the other adapted precoding granularity for a PRB bundling at a boundary of the downlink frequency subband, such that the PRB bundling at the boundary does not overlap with a guardband or uplink frequency subband in the SBFD time unit.

In some embodiments, the terminal device 110 may determine the PRB bundling by: determining, based on the precoding granularity, a plurality of PRB bundling within the one or more downlink frequency subbands by omitting PRBs of a guardband and uplink frequency subband in the SBFD time unit, wherein one of the plurality of PRB bundling includes two subsets of PRBs, and the two subsets of PRBs are located in two downlink frequency subbands of the SBFD time unit, respectively.

In some embodiments, the precoding granularity is a wideband granularity and the downlink channel is configured on more than one downlink frequency subband in the SBFD time unit. The terminal device 110 may determine the PRB bundling by: determining, in the SBFD time unit, a first PRB bundling within a first downlink frequency subband and a second PRB bundling within a second downlink frequency subband; and applying the same precoding matrix to the first PRB bundling and the second PRB bundling.

In some embodiments, the precoding granularity is a wideband granularity and the downlink channel is configured on more than one downlink frequency subband in the SBFD time unit. The terminal device 110 may determine the PRB bundling by: determining, in the SBFD time unit, a first PRB bundling within a first downlink frequency subband and a second PRB bundling within a second downlink frequency subband; and applying a first precoding matrix to the first PRB bundling and a second precoding matrix to the second PRB bundling, respectively.

In some embodiments, the wideband granularity is set based on a number of PRBs scheduled for the downlink channel and a bandwidth of the downlink frequency subband in the SBFD time unit. The precoding granularity is set to the wideband granularity in the case that a first bandwidth of PRBs allocated in a downlink frequency subband is equal to or above half of a second bandwidth of the downlink frequency subband.

In some embodiments, the terminal device 110 may further: receive, from the network device, a first indication indicating that same precoding matrix is applied to the downlink frequency subbands in the SBFD time unit; or receive, from the network device, a second indication indicating that different precoder matrices are applied to downlink frequency subbands in the SBFD time unit, wherein the first indication or second indication are determined based on channel states of the downlink frequency subbands.

In some embodiments, the precoding granularity comprises at least one of: two PRBs, four PRBs, eight PRBs, sixteen PRBs, thirty two PRBs, a subband or a wideband granularity.

In some embodiments, the terminal device 110 may further: determine a precoding matrix to be applied based on the PRB bundling having the precoding granularity or the other adapted precoding granularity; and decode, based on the precoding matrix, a downlink shared channel from the network device.

FIG. 7 illustrates a flowchart of a method 700 of communication implemented at a network device in accordance with some embodiments of the present disclosure. The method 700 can be implemented at the network device 120 shown in FIG. 1. For the purpose of discussion, the method 700 will be described with reference to FIG. 1. It is to be understood that the method 700 may include additional acts not shown and/or may omit some shown acts, and the scope of the present disclosure is not limited in this regard.

At 810, the network device 120 determines, based on one or more downlink frequency subbands of a SBFD time unit, a precoding granularity for a downlink channel in the SBFD time unit. The SBFD time unit is configured with frequency subbands for different link directions. At 820, the network device transmits to a terminal device, a physical resource block (PRB) bundling configuration indicating the precoding granularity.

In some embodiments, the network device 120 may further: determine, within one or more downlink frequency subbands of the SBFD time unit, a PRB bundling having the precoding granularity or another adapted precoding granularity.

In some embodiments, the network device 120 may determine the PRB bundling having the other adapted precoding granularity by: determining whether an initial PRB bundling divided based on the precoding granularity overlaps with both a downlink frequency subband and another frequency subband in the SBFD time unit; determining, based on determining that the initial PRB bundling overlaps with both the downlink frequency subband and the other frequency subband, a first number of PRBs in the initial PRB bundling as the other adapted precoding granularity, wherein the first number of PRBs within the initial PRB bundling does not overlap with the other frequency subband; and replacing the initial PRB bundling with the PRB bundling having the other adapted precoding granularity.

In some embodiments, the network device 120 may determine PRB bundling having the other adapted precoding granularity by: determining, based on a downlink frequency subband in the SBFD time unit and the precoding granularity, the other adapted precoding granularity for a PRB bundling at a boundary of the downlink frequency subband, such that the PRB bundling at the boundary does not overlap with a guardband or uplink frequency subband in the SBFD time unit.

In some embodiments, the network device 120 may determine the PRB bundling by: determining, based on the precoding granularity, a plurality of PRB bundling within the one or more downlink frequency subbands by omitting PRBs of a guardband and uplink frequency subband in the SBFD time unit, wherein one of the plurality of PRB bundling includes two subsets of PRBs, and the two subsets of PRBs are located in two downlink frequency subbands of the SBFD time unit, respectively.

In some embodiments, the precoding granularity is a wideband granularity and the downlink channel is configured on more than one downlink frequency subband in the SBFD time unit. The network device 120 may determine the PRB bundling by: determining, in the SBFD time unit, a first PRB bundling within a first downlink frequency subband and a second PRB bundling within a second downlink frequency subband; and applying the same precoding matrix to the first PRB bundling and the second PRB bundling.

In some embodiments, the precoding granularity is a wideband granularity and the downlink channel is configured on more than one downlink frequency subband in the SBFD time unit. The network device 120 may determine the PRB bundling by: determining, in the SBFD time unit, a first PRB bundling within a first downlink frequency subband and a second PRB bundling within a second downlink frequency subband; and applying a first precoding matrix to the first PRB bundling and a second precoding matrix to the second PRB bundling, respectively.

In some embodiments, the wideband granularity is set based on a number of PRBs scheduled for the downlink channel and a bandwidth of the downlink frequency subband in the SBFD time unit. The precoding granularity is set to the wideband granularity in the case that a first bandwidth of PRBs allocated in a downlink frequency subband is equal to or above half of a second bandwidth of the downlink frequency subband.

In some embodiments, the network device may further determine, in the SBFD time unit, whether a difference between a first channel state of a first downlink frequency subband and a second channel state of a second downlink frequency subband is equal to or above a threshold; transmit, based on determining that the difference is not above the threshold, a first indication to the terminal device, wherein the first indication indicates that same precoding matrix is applied to the downlink frequency subbands in the SBFD time unit; and transmit, based on determining that the difference is equal to or above the threshold, a second indication to the terminal device, wherein the second indication indicates different precoder matrices are applied to downlink frequency subbands in the SBFD time unit.

In some embodiments, the precoding granularity comprises at least one of: two PRBs, four PRBs, eight PRBs, sixteen PRBs, thirty two PRBs, a subband, or a wideband granularity.

In some embodiments, the network device may further: determine a precoding matrix to be applied based on the PRB bundling having the precoding granularity or another adapted precoding granularity; encode a downlink shared channel based on the precoding matrix; and transmit the precoded downlink shared channel to the terminal device.

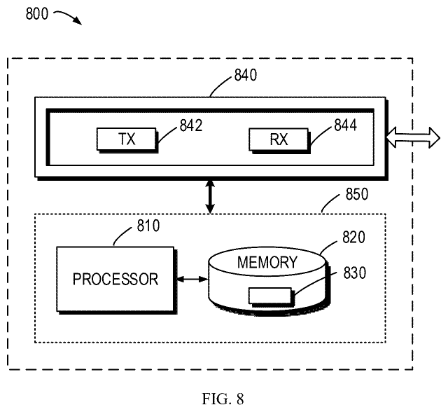

FIG. 8 is a simplified block diagram of a device 800 that is suitable for implementing some embodiments of the present disclosure. The device 800 can be considered as a further example embodiment of the terminal device 110 or network device 120 as shown in FIG. 1. Accordingly, the device 800 can be implemented at or as at least a part of the above network devices or terminal devices.

As shown, the device 800 includes a processor 810, a memory 820 coupled to the processor 810, a suitable transceiver 840 coupled to the processor 810, and a communication interface coupled to the transceiver 840. The memory 810 stores at least a part of a program 830. The transceiver 840 may be for bidirectional communications or a unidirectional communication based on requirements. The transceiver 840 may include at least one of a transmitter 842 and a receiver 844. The transmitter 842 and the receiver 944 may be functional modules or physical entities. The transceiver 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, Sl/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1-7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises circuitry configured to perform method 600.

In some embodiments, a network device comprises circuitry configured to perform method 700.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique, devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2 to 7. Generally, program modules include routines, programs, libraries, objects, classes, components, data structures, or the like that perform particular tasks or implement particular abstract data types. The functionality of the program modules may be combined or split between program modules as desired in various embodiments.

Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

A terminal device comprises a processor. The processor is configured to cause the terminal device to receive, from a network device, a physical resource block (PRB) bundling configuration that indicates a precoding granularity for a downlink channel in a subband non-overlapping full duplex (SBFD) time unit. The SBFD time unit is configured with frequency subbands for different link directions. The terminal device is further caused to determine, based on the PRB bundling configuration and within one or more downlink frequency subbands of the SBFD time unit, a PRB bundling having the precoding granularity or another adapted precoding granularity.

In one embodiment, wherein the terminal device is caused to determine the PRB bundling having the other adapted precoding granularity by: determining whether an initial PRB bundling divided based on the precoding granularity overlaps with both a downlink frequency subband and another frequency subband in the SBFD time unit; determining, based on determining that the initial PRB bundling overlaps with both the downlink frequency subband and the other frequency subband, a first number of PRBs in the initial PRB bundling as the other adapted precoding granularity, wherein the first number of PRBs within the initial PRB bundling does not overlap with the other frequency subband; and replacing the initial PRB bundling with the PRB bundling having the other adapted precoding granularity.

In one embodiment, wherein the terminal device is caused to determine the PRB bundling having the other adapted precoding granularity by: determining, based on a downlink frequency subband in the SBFD time unit and the precoding granularity, the other adapted precoding granularity for a PRB bundling at a boundary of the downlink frequency subband, such that the PRB bundling at the boundary does not overlap with a guardband or uplink frequency subband in the SBFD time unit.

In one embodiment, wherein the terminal device is caused to determine the PRB bundling by: determining, based on the precoding granularity, a plurality of PRB bundling within the one or more downlink frequency subbands by omitting PRBs of a guardband and uplink frequency subband in the SBFD time unit, wherein one of the plurality of PRB bundling includes two subsets of PRBs, and the two subsets of PRBs are located in two downlink frequency subbands of the SBFD time unit, respectively.

In one embodiment, wherein the precoding granularity is a wideband granularity and the downlink channel is configured on more than one downlink frequency subband in the SBFD time unit, and wherein the terminal device is caused to determine the PRB bundling by: determining, in the SBFD time unit, a first PRB bundling within a first downlink frequency subband and a second PRB bundling within a second downlink frequency subband; and applying the same precoding matrix to the first PRB bundling and the second PRB bundling.

In one embodiment, wherein the precoding granularity is a wideband granularity and the downlink channel is configured on more than one downlink frequency subband in the SBFD time unit, and wherein the terminal device is caused to determine the PRB bundling by: determining, in the SBFD time unit, a first PRB bundling within a first downlink frequency subband and a second PRB bundling within a second downlink frequency subband; and applying a first precoding matrix to the first PRB bundling and a second precoding matrix to the second PRB bundling, respectively.

In one embodiment, wherein the wideband granularity is set based on a number of PRBs scheduled for the downlink channel and a bandwidth of the downlink frequency subband in the SBFD time unit; wherein the precoding granularity is set to the wideband granularity in the case that a first bandwidth of PRBs allocated in a downlink frequency subband is above half of a second bandwidth of the downlink frequency subband.

In one embodiment, wherein the terminal device is further caused to: receive, from the network device, a first indication indicating that same precoding matrix is applied to the downlink frequency subbands in the SBFD time unit; or receive, from the network device, a second indication indicating that different precoder matrices are applied to downlink frequency subbands in the SBFD time unit, wherein the first indication or second indication are determined based on channel states of the downlink frequency subbands.

In one embodiment, wherein the precoding granularity comprises at least one of: two PRBs, four PRBs, eight PRBs, sixteen PRBs, thirty two PRBs, a subband or a wideband granularity.

In one embodiment, wherein the terminal device is further caused to: determine a precoding matrix to be applied based on the PRB bundling having the precoding granularity or the other adapted precoding granularity; and decode, based on the precoding matrix, a downlink shared channel from the network device.

A network device comprises a processor. The processor is configured to cause the network device to: determine, based on one or more downlink frequency subbands of an SBFD time unit, a precoding granularity for a downlink channel in the SBFD time unit. The SBFD time unit is configured with frequency subbands for different link directions. The network device is further caused to transmit, to a terminal device, a PRB bundling configuration indicating the precoding granularity.

In one embodiment, wherein the network device is further caused to: determine, within one or more downlink frequency subbands of the SBFD time unit, a PRB bundling having the precoding granularity or another adapted precoding granularity.

In one embodiment, wherein the network device is caused to determine the PRB bundling having the other adapted precoding granularity by: determining whether an initial PRB bundling divided based on the precoding granularity overlaps with both a downlink frequency subband and another frequency subband in the SBFD time unit; determining, based on determining that the initial PRB bundling overlaps with both the downlink frequency subband and the other frequency subband, a first number of PRBs in the initial PRB bundling as the other adapted precoding granularity, wherein the first number of PRBs within the initial PRB bundling does not overlap with the other frequency subband; and replacing the initial PRB bundling with the PRB bundling having the other adapted precoding granularity.

In one embodiment, wherein the network device is caused to determine PRB bundling having the other adapted precoding granularity by: determining, based on a downlink frequency subband in the SBFD time unit and the precoding granularity, the other adapted precoding granularity for a PRB bundling at a boundary of the downlink frequency subband, such that the PRB bundling at the boundary does not overlap with a guardband or uplink frequency subband in the SBFD time unit.

In one embodiment, wherein the network device is caused to determine the PRB bundling by: determining, based on the precoding granularity, a plurality of PRB bundling within the one or more downlink frequency subbands by omitting PRBs of a guardband and uplink frequency subband in the SBFD time unit, wherein one of the plurality of PRB bundling includes two subsets of PRBs, and the two subsets of PRBs are located in two downlink frequency subbands of the SBFD time unit, respectively.

In one embodiment, wherein the precoding granularity is a wideband granularity and the downlink channel is configured on more than one downlink frequency subband in the SBFD time unit, and wherein the terminal device is caused to determine the PRB bundling by: determining, in the SBFD time unit, a first PRB bundling within a first downlink frequency subband and a second PRB bundling within a second downlink frequency subband; and applying the same precoding matrix to the first PRB bundling and the second PRB bundling.

In one embodiment, wherein the precoding granularity is a wideband granularity and the downlink channel is configured on more than one downlink frequency subband in the SBFD time unit, and wherein the terminal device is caused to determine the PRB bundling by: determining, in the SBFD time unit, a first PRB bundling within a first downlink frequency subband and a second PRB bundling within a second downlink frequency subband; and applying a first precoding matrix to the first PRB bundling and a second precoding matrix to the second PRB bundling, respectively.

In one embodiment, wherein the wideband granularity is set based on a number of PRBs scheduled for the downlink channel and a bandwidth of the downlink frequency subband in the SBFD time unit; wherein the precoding granularity is set to the wideband granularity in the case that a first bandwidth of PRBs allocated in a downlink frequency subband is above half of a second bandwidth of the downlink frequency subband.

In one embodiment, wherein the network device is further caused to: determine, in the SBFD time unit, whether a difference between a first channel state of a first downlink frequency subband and a second channel state of a second downlink frequency subband is above a threshold; transmit, based on determining that the difference is not above the threshold, a first indication to the terminal device, wherein the first indication indicates that same precoding matrix is applied to the downlink frequency subbands in the SBFD time unit; and transmit, based on determining that the difference is above the threshold, a second indication to the terminal device, wherein the second indication indicates different precoder matrices are applied to downlink frequency subbands in the SBFD time unit.

In one embodiment, wherein the precoding granularity comprises at least one of: two PRBs, four PRBs, eight PRBs, sixteen PRBs, thirty two PRBs, a subband, or a wideband granularity.

In one embodiment, wherein the network device is further caused to: determine a precoding matrix to be applied based on the PRB bundling having the precoding granularity or another adapted precoding granularity; encode a downlink shared channel based on the precoding matrix; and transmit the precoded downlink shared channel to the terminal device.

A method of communication, comprising: receiving, at a terminal device from a network device, a physical resource block (PRB) bundling configuration that indicates a precoding granularity for a downlink channel in a subband non-overlapping full duplex (SBFD) time unit, wherein the SBFD time unit is configured with frequency subbands for different link directions; and determining, based on the PRB bundling configuration and within one or more downlink frequency subbands of the SBFD time unit, a PRB bundling having the precoding granularity or another adapted precoding granularity.

A method of communication, comprising: determining, based on one or more downlink frequency subbands of a subband non-overlapping full duplex (SBFD) time unit, a precoding granularity for a downlink channel in the SBFD time unit, wherein the SBFD time unit is configured with frequency subbands for different link directions; and transmitting, to a terminal device, a physical resource block (PRB) bundling configuration indicating the precoding granularity.

A computer readable medium having instructions stored thereon, the instructions,

1-20. (canceled)

21. A method of a terminal device, the method comprising:
receiving, from a network device, information indicating a size of a physical resource block (PRB) bundling for a downlink (DL) channel;
determining, based on the size of the PRB bundling, a precoding granularity; and
determining at least one Precoding Resource block Group (PRG) that partitions a Bandwidth Part (BWP) with the precoding granularity,
wherein in a case in which the terminal device is configured with Sub Band non-overlapping Full Duplex (SBFD), one or more of the at least one PRG partially overlaps with a PRB outside a DL sub-band of a SBFD symbol.

22. The method according to claim 21, wherein the precoding granularity is one of values among two PRBs, four PRBs, eight PRBs, sixteen PRBs, thirty two PRBs, a subband or a wideband granularity.

23. A terminal device comprising:
at least one processor; and
at least one memory coupled to the at least one processor, the at least one memory storing instructions that, when executed by the at least one processor, cause the at least one processor to:
receive, from a network device, information indicating a size of a physical resource block (PRB) bundling for a downlink (DL) channel;
determine, based on the size of the PRB bundling, a precoding granularity; and
determine at least one Precoding Resource block Group (PRG) that partitions a Bandwidth Part (BWP) with the precoding granularity,
wherein in a case in which the terminal device is configured with Sub Band non-overlapping Full Duplex (SBFD), one or more of the at least one PRG partially overlaps with a PRB outside a DL sub-band of a SBFD symbol.

24. The terminal device according to claim 23, wherein the precoding granularity is one of values among two PRBs, four PRBs, eight PRBs, sixteen PRBs, thirty two PRBs, a subband or a wideband granularity.
